(19) United States
(12) Patent Application Publication
(10) Pub. No.: US 2026/0212853 A1
(43) Pub. Date: Jul. 23, 2026

(54) MOLDED FASTENERS ON COMPRESSION MOLDING INSULATORS

(71) Applicant: GM GLOBAL TECHNOLOGY OPERATIONS LLC, Detroit, MI (US)

(72) Inventors: Felipe Guillermo Salazar Prieto, Lerma de Villada (MX); Rafael Cuarenta, Almoloya de Juarez (MX)

(73) Assignee: GM GLOBAL TECHNOLOGY OPERATIONS LLC, Detroit, MI (US)

(21) Appl. No.: 19/032,666

(22) Filed: Jan. 21, 2025

(51) Int. Cl. G10K 11/162; F16B 43/00

(52) U.S. Cl. CPC G10K 11/162; F16B 43/001

(57) ABSTRACT

Disclosed is an acoustic insulator including a polymeric material and having compression molded features formed therein and a slot formed therein constructed and arranged to fasten the acoustic insulator on a male fastener.

### INTRODUCTION

The technical field generally relates to vehicle acoustic insulators, and methods of making and assembling the same.

An acoustic insulator may be attached a vehicle body using washers and nuts. In the case of an acoustic insulator for a vehicle engine compartment firewall, an installer must hang the acoustic insulator on eight studs on the firewall and then retrieve washers and nuts from containers and then install, by hand, a washer and nut for each of eight studs on the firewall.

It is desirable to provide an acoustic insulator and method of attaching the same to a vehicle body that does not necessarily require the use of washers and nuts. Furthermore, other desirable features and characteristics of the patentable variations will become apparent from the subsequent detailed description and the appended claims, taken in conjunction with the accompanying drawings and the foregoing introduction.

### SUMMARY

A number of variations may include a product including an acoustic insulator including a polymeric material, the acoustic insulator includes a first portion having a first stiffness and a second portion having a second stiffness greater than the first stiffness, the second portion having a slot defined at least in part by a first edge of the second portion and a second edge of the second portion, the first edge of the second portion and the second edge of the second portion each being constructed and arranged to fasten the acoustic insulator on a male fastener.

A number of variations may include a product further including a male fastener extending through the slot.

A number of variations may include a product wherein the acoustic insulator includes a third portion having a third stiffness greater than the second stiffness.

A number of variations may include a product wherein the second portion has a truncated cone shape.

A number of variations may include a product wherein the acoustic insulator further includes a plurality of guide markers formed in the acoustic insulator pointing toward the slot.

A number of variations may include a product wherein each of the plurality of guide markers has a triangle shape.

A number of variations may include a product wherein the male fastener is a weld stud welded to a body of a vehicle.

A number of variations may include a product wherein the weld stud includes a first rib and a second rib spaced apart from the first rib by a valley, wherein the first edge engages at least one of the first rib or the second rib, and wherein the second edge engages at least one of the first rib or the second rib so that the acoustic insulator is fastened to the weld stud.

A number of variations may include a product wherein the weld stud includes a spiral thread, the weld stud being welded to the body of the vehicle, and wherein the first edge and the second edge each engage the spiral thread to fasten the acoustic insulator to the body of the vehicle.

A number of variations may include a method including providing an acoustic insulator including a polymeric material, the acoustic insulator having a first portion and a second portion; cutting a slot in the second portion, wherein the slot is define by a first edge of the second portion and a second edge of the second portion, the first edge of the second portion and the second edge of the second portion each being constructed and arrange to fasten the acoustic insulator to a male fastener extending through the slot.

A number of variations may include a method further including placing the acoustic insulator on a male fastener so the male fastener extends through the slot.

A number of variations may include a method wherein the providing the acoustic insulator includes compression molding the first portion to a have a first stiffness, and further including compression molding the second portion to have a second stiffness greater than the first stiffness.

A number of variations may include a method wherein the providing the acoustic insulator includes compression molding a third portion to have a third stiffness greater than the second stiffness.

A number of variations may include a method wherein the providing the acoustic insulator includes compression molding the second portion to have a truncated cone shape.

A number of variations may include a method wherein the providing the acoustic insulator includes compression molding a plurality of guide markers in the acoustic insulator pointing toward the slot.

A number of variations may include a method wherein each of the plurality of guide markers has a triangle shape.

A number of variations may include a method wherein the male fastener is a weld stud welded to a body of a vehicle.

A number of variations may include a method wherein the weld stud includes a first rib and second rib spaced apart from the first rib by a valley, wherein the first edge of the second portion engages at least one of the first rib or the second rib, and wherein the second edge of the second portion engages at least one of the first rib or the second rib so that the acoustic insulator is fastened to the weld stud.

A number of variations may include a method wherein the weld stud includes a spiral thread, the weld stud being welded to a body of a vehicle, and wherein the first edge of the second portion and the second edge of the second portion each engages the spiral thread to fasten the acoustic insulator to the body of the vehicle.

A number of variations may include a vehicle including a body and a weld stud welded to the body, the weld stud having a spiral tread; an acoustic insulator including a polymeric material, the acoustic insulator includes a first portion having a first stiffness and a second portion having a second stiffness greater than the first stiffness, the second portion having a slot defined at least in part by a first edge and a second edge of the second portion; wherein the weld stud extends through the slot so that the acoustic insulator is fastened to the body of the vehicle.

### BRIEF DESCRIPTION OF THE DRAWINGS

The illustrative variations will hereinafter be described in conjunction with the following drawing figures, wherein like numerals denote like elements, and wherein:

FIG. 1 is a schematic illustration of a molded acoustic insulator according to a number of variations;

FIG. 2 is a schematic illustration of a product including a molded acoustic insulator and a male fastener extending therethrough according to a number of variations;

FIG. 3 is a sectional view taken along line 3-3 of the product illustrated in FIG. 2;

FIG. 4 is a sectional view of a product including a molded acoustic insulator according to a number of variations;

FIG. 5 is a schematic illustration of a vehicle including a variety of components onto which a molded acoustic insulator may be attached according to a number of variations;

FIG. 6 is a schematic illustration of a male fastener onto which a molded acoustic insulator may be attached according to a number of variations; and

FIG. 7 is a schematic illustration of a vehicle body including an engine compartment defined in part by a firewall onto which a molded acoustic insulator may be attached according to a number of variations.

### DETAILED DESCRIPTION

The following detailed description is merely illustrative in nature and is not intended to limit the application and uses. Furthermore, there is no intention to be bound by any expressed or implied theory presented in the preceding introduction, brief description of the drawings, brief summary or the following detailed description.

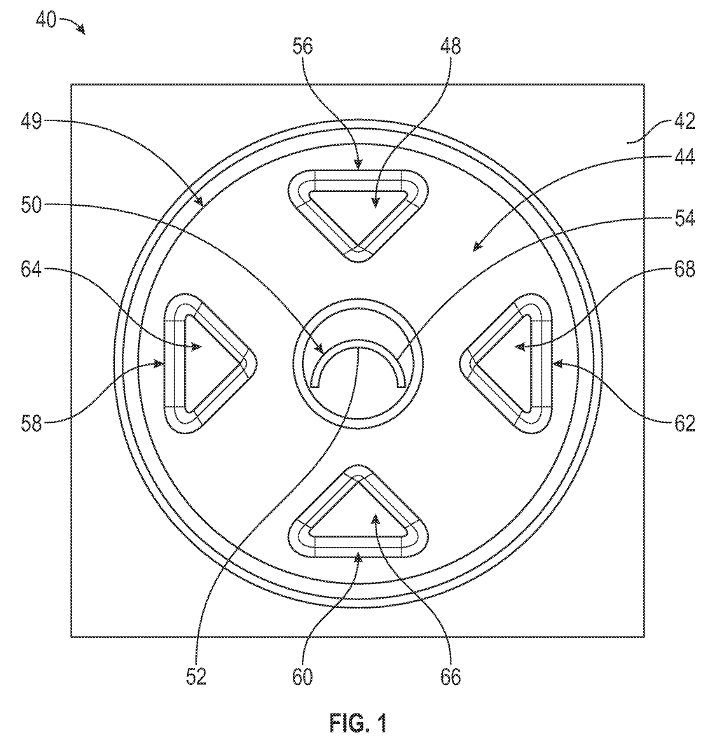

FIG. 1 illustrates a product 40 which may be an acoustic insulator 42 which may include a first portion 44 having a first stiffness, a second portion 46 having a second stiffness, and third portion 48 having a third stiffness. In a number of variations, the second stiffness is greater than the first stiffness, and the third stiffness is greater than the second stiffness. The term “stiffness” as used herein is a materials ability to resist deformation when an external force is applied. In a number of variations, the first portion 44 may have a first thickness, the second portion 46 may have a second thickness, and the third portion 48 may have a third thickness. In a number of variations, the first thickness may be greater than the second thickness, and the second thickness may be greater than the third thickness. In a number of variations, the first portion 44 may have a first density, the second portion 46 may have a second density, and the third portion 48 may have a third density. In a number of variations, the first density may be less than the second density, and the second thickness may be less than the third density. In a number of variations, a fourth portion 43, may have a truncated cone shape. In a number of variation the base 49 In a number of variations, the fourth portion 43 may include the first portion 44, the second portion 46, and the third portion 48.

In a number of variations, the product 40 may be made by selective compression molding wherein the acoustic insulator 42 is subjected to a first molding pressure to form the first portion 44, a second molding pressure to form the second portion 46, and a third molding pressure to form the third portion 48. In a number of variations, the acoustic insulator 42 may include a polymeric material. In a number of variations, the acoustic insulator 42 may include a polyurethane foam. In a number of variations, the acoustic insulator 42 may include a filler such as, but not limited to, fiberglass. By compression molding at different pressures the first portion 44, the second portion 46, and the third portion 48 have a different stiffness, thickness, and density.

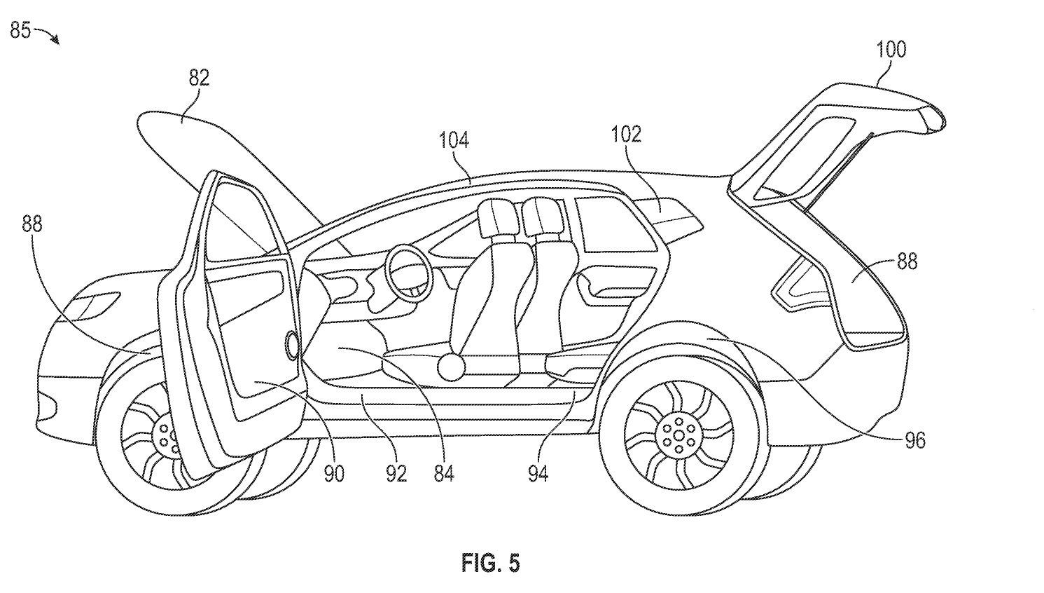

In a number of variations, the second portion 46 may have a slot 50 formed therein defined in part by a first curved edge 52 and the second curved edge 54 of the second portion 46. In a number of variations, the first curved edge 52 may have a convex shape and the second curved edge 54 may have a concave shaped. In a number of variations, the first curved edge 52 may have a semicircular shape having a consistent first radius, and the second curved edge 54 may have a consistent second radius. In a number of variations, the first curved edge 52 may be arc shaped, and the second curved edge 54 may be arc shaped. In a number of variations, the first curved edge 52 may have a varying radius along a length of the first curved edge 52, and the second curved edge 54 may have a varying radius along a length of the second curved edge 54. In a number of variations, the slot 50 may be formed by water jet cutting or die cutting. In a number of variations, the width, as shown by line W-W in FIG. 4, of the slot 50 may range from about 2-10 mm, about 3-7, or about 5 mm. In a number of variations, the width may be constant or substantially constant along the length of the slot 50.

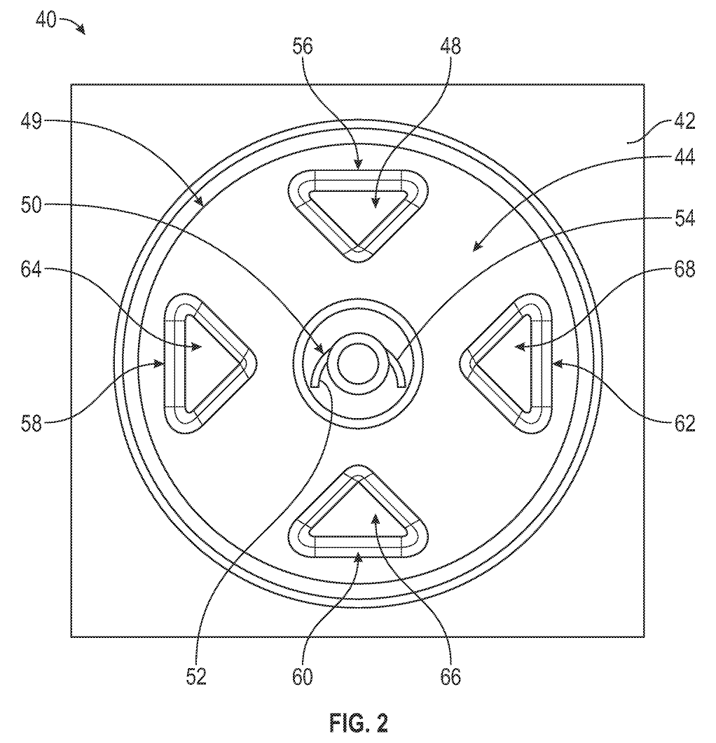

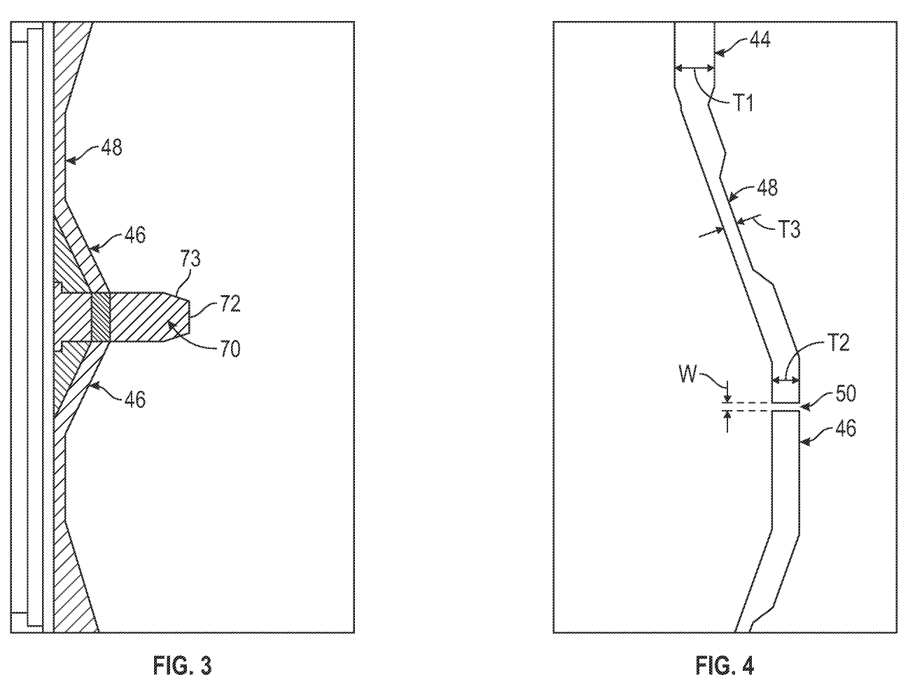

In a number of variations, a plurality of guide markers may be molded into the acoustic insulator 42 to guide an installer for inserting a male fastener 70 (as shown in FIGS. 2-3) into the acoustic insulator 42. For example, a first guide marker 56 may be formed in the acoustic insulator 42 and may be spaced apart from a second guide marker 58, which may be spaced apart from a third guide marker 60, which may be spaced apart from a fourth guide marker. Each of the first guide marker 56, second guide marker 58, third guide marker 60, fourth guide marker 62 may have a triangular shape and may be positioned to point towards the slot 50 formed in the second portion 46. FIG. 3 illustrates a number of variations, wherein the male fastener 70 may have a tapered portion 73 near a first end 72.

FIG. 4 is a sectional view of a product including a molded acoustic insulator according to a number of variations. In a number of variations, the first portion 44 may have a thickness as indicated by line T1 of about 3-5 mm, the second portion in a thickness as indicated by line T2 of about 1-3 mm, and the third portion may have a thickness as indicated by line T2 of about 1-2 mm. In a number of variations, the first portion 44 may have a thickness as indicated by line T1 of about 4 mm, the second portion in a thickness as indicated by line T2 of about 2 mm, and the third portion may have a thickness as indicated by line T2 of about 1 mm.

FIG. 5 is a schematic illustration of a vehicle 85 wherein the acoustic insulator 42 may be fastened to a variety of locations of the vehicle 85. For example, the acoustic insulator 42 may be fastened to at least one of a passenger compartment side of a firewall 84, an underside of a hood 86, an inside of front wheel well 88, an inside a door 90, a front floor panel 92, a rear floor panel 94, an inside of a rear wheel well 96, an inside of a liftgate or trunk lid 100, a rear deck 102, or the passenger cabin side of a roof 104.

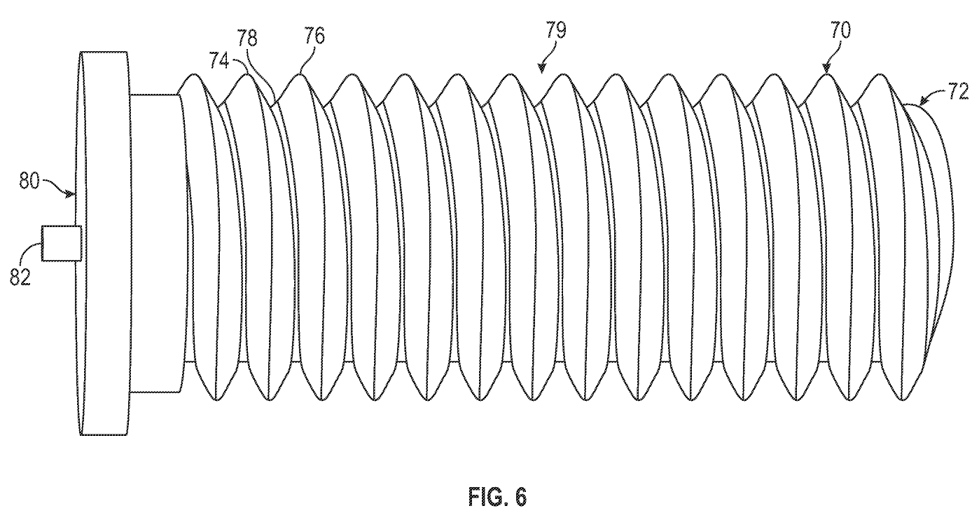

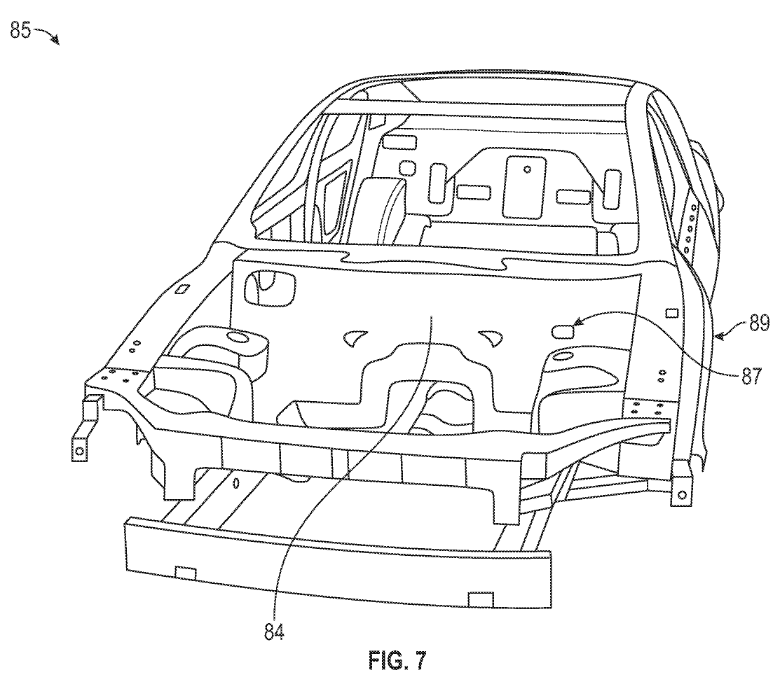

FIG. 6 is a schematic illustration of a male fastener 70 having a first end 72, and a first rib 74 and a second rib 76 spaced from each other by a valley 78. The male fastener 70 may include a second end 80 which may be welded to a vehicle body panel. The second end 80 may also include a projection 82 that may be inserted into a through hole a recess in a vehicle panel. In a number of variations, the male fastener 70 may be a weld stud including a spiral thread 79 on the outer surface thereof. The weld stud may be 6 mm in diameter.

FIG. 7 is a schematic illustration of a body 89 of a vehicle 85 including an engine compartment 87 defined in part by a firewall 84 onto which a molded acoustic insulator may be fastened to the engine compartment 87 side of the firewall 84 according to a number of variations.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product comprising:
an acoustic insulator comprising a polymeric material, the acoustic insulator comprises a first portion having a first stiffness and a second portion having a second stiffness greater than the first stiffness, the second portion having a slot defined at least in part by a first edge of the second portion and a second edge of the second portion, the first edge of the second portion and the second edge of the second portion each being constructed and arranged to fasten the acoustic insulator on a male fastener.

2. The product as set forth in claim 1 further comprising a male fastener extending through the slot.

3. The product as set forth in claim 1 wherein the acoustic insulator comprises a third portion having a third stiffness greater than the second stiffness.

4. The product as set forth in claim 1 wherein the second portion has a truncated cone shape.

5. The product as set forth in claim 1 wherein the acoustic insulator further comprises a plurality of guide markers formed in the acoustic insulator pointing toward the slot.

6. The product as set forth in claim 5 wherein each of the plurality of guide markers has a triangle shape.

7. The product as set forth in claim 2 wherein the male fastener is a weld stud welded to a body of a vehicle.

8. The product as set forth in claim 7 wherein the weld stud includes a first rib and a second rib spaced apart from the first rib by a valley, wherein the first edge engages at least one of the first rib or the second rib, and wherein the second edge engages at least one of the first rib or the second rib so that the acoustic insulator is fastened to the weld stud.

9. The product as set forth in claim 7 wherein the weld stud comprises a spiral thread, the weld stud being welded to the body of the vehicle, and wherein the first edge and the second edge each engage the spiral thread to fasten the acoustic insulator to the body of the vehicle.

10. A method comprising:
providing an acoustic insulator comprising a polymeric material, the acoustic insulator having a first portion and a second portion; and
cutting a slot in the second portion, wherein the slot is defined by a first edge of the second portion and a second edge of the second portion, the first edge of the second portion and the second edge of the second portion each being constructed and arrange to fasten the acoustic insulator to a male fastener extending through the slot.

11. The method as set forth in 10 further comprising: placing the acoustic insulator on a male fastener so the male fastener extends through the slot.

12. The method as set forth in claim 10 wherein the providing the acoustic insulator comprises: compression molding the first portion to a have a first stiffness, and further comprising compression molding the second portion to have a second stiffness greater than the first stiffness.

13. The method as set forth in claim 12 wherein the providing the acoustic insulator comprises: compression molding a third portion to have a third stiffness greater than the second stiffness.

14. The method as set forth in claim 10 wherein the providing the acoustic insulator comprises: compression molding the second portion to have a truncated cone shape.

15. The method as set forth in claim 10 wherein the providing the acoustic insulator comprises: compression molding a plurality of guide markers in the acoustic insulator pointing toward the slot.

16. The method as set forth in claim 15 wherein each of the plurality of guide markers has a triangle shape.

17. The method as set forth in claim 11 wherein the male fastener is a weld stud welded to a body of a vehicle.

18. The method as set forth in claim 17 wherein the weld stud includes a first rib and second rib spaced apart from the first rib by a valley, wherein the first edge of the second portion engages at least one of the first rib or the second rib, and wherein the second edge of the second portion engages at least one of the first rib or the second rib so that the acoustic insulator is fastened to the weld stud.

19. The method as set forth in claim 17 wherein the weld stud includes a spiral thread, the weld stud being welded to a body of a vehicle, and wherein the first edge of the second portion and the second edge of the second portion each engages the spiral thread to fasten the acoustic insulator to the body of the vehicle.

20. A vehicle comprising:
a body and a weld stud welded to the body, the weld stud having a spiral tread;
an acoustic insulator comprising a polymeric material, the acoustic insulator comprises a first portion having a first stiffness and a second portion having a second stiffness greater than the first stiffness, the second portion having a slot defined at least in part by a first edge and a second edge of the second portion; and
wherein the weld stud extends through the slot so that the acoustic insulator is fastened to the body of the vehicle.
